(19) United States
(12) Patent Application Publication
(10) Pub. No.: US 2026/0018819 A1
(43) Pub. Date: Jan. 15, 2026

(54) SIGNAL TERMINAL AND ELECTRICAL CONNECTOR

(71) Applicant: LOTES CO., LTD, Keelung (TW)

(72) Inventor: Lin Han, Guangzhou (CN)

(21) Appl. No.: 19/027,012

(22) Filed: Jan. 17, 2025

(30) Foreign Application Priority Data
Jul. 10, 2024 (CN) 202421634544.9
Dec. 20, 2024 (CN) 202423167138.9

(51) Int. Cl. H01R 13/24; H01R 13/6586

(52) U.S. Cl. CPC H01R 13/2407; H01R 13/6586

(57) ABSTRACT

A signal terminal and an electrical connector, and the electrical connector includes a plurality of terminal modules. Each terminal module includes two signal terminals. Each signal terminal includes a main body and an attaching portion attached to each other, a first elastic arm extending from the main body, and a second elastic arm extending from the attaching portion. The first elastic arm and the second elastic arm counteract the opposing sliding forces when contacting a circuit broad, thus forming dual signal transmission paths, and enhancing the transmission rates.

### CROSS-REFERENCE TO RELATED PATENT APPLICATION

This non-provisional application claims priority to and the benefit of, pursuant to 35 U.S.C. § 119(a), patent application Serial No. CN202421634544.9 filed in China on Jul. 10, 2024, and patent application Serial No. CN202423167138.9 filed in China on Dec. 20, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a signal terminal and an electrical connector, and more particularly to a signal terminal and an electrical connector for elastically abutting against a circuit board.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Existing electrical connectors used for transmitting high-speed signals generally include multiple signal terminals, each signal terminal comprising a main body. A contact portion extends from one end of the main body, while an elastic arm extends from the other end of the main body. The elastic arm is provided with an abutting portion for abutting against a conductive pad of the circuit board to form an electrical connection.

However, the elastic arms of multiple signal terminals are all bent and extended in a same direction. When the electrical connector is installed on the circuit board, multiple sliding forces in the same direction are prone to accumulate, causing misalignment between multiple abutting portions and their corresponding conductive pads. This misalignment is unfavorable for stable contact between the signal terminals and the circuit board. Furthermore, the elastic arms are often formed by a single bend from the main body, resulting in shorter moment arms. The elastic performance during elastic compression contact with the circuit board is relatively poor, which is disadvantageous for maintaining good elasticity after multiple assembly and disassembly operations.

Additionally, as the demand for high-speed transmission rates in the electronics industry continues to increase, each signal terminal with only one elastic arm for conduction with the circuit board form a single signal transmission path, which is not conducive to further improving the transmission rate of each signal terminal.

Therefore, a heretofore unaddressed need to design an improved signal terminal and an electrical connector exists in the art to address the aforementioned deficiencies and inadequacies.

### SUMMARY

In view of the deficiencies of the background art, the present invention is directed to a signal terminal and an electrical connector, designed to address the issues in the background technology by incorporating a first elastic arm and a second elastic arm of each signal terminal that counteract opposing sliding forces during mounting and form dual signal transmission paths. The signal terminal includes a main body and an attaching portion provided to be integrally or separately formed. The attaching portion is attached to the main body, increasing the thickness of the signal terminal at the attaching location, thereby enhancing the cross-sectional area of the signal terminal. The first elastic arm includes a first extending arm bending and extending from the main body and a first abutting arm bending and extending reversely from the first extending arm, and the second elastic arm includes a second extending arm extending from the attaching portion along a direction away from the first extending arm and a second abutting arm bending and extending from the second extending arm toward the first abutting arm, such that both the first elastic arm and the second elastic arm are formed by bending and extending twice with longer moment arms, thus enhancing the elastic performance of the first elastic arm and the second elastic arm, and facilitating better elastic contact between the signal terminal and the circuit board. Further, the first extending arm and the second extending arm are provided to extend in directions away from each other, and the first abutting arm and the second abutting arm are provided to extend in directions toward each other. Thus, when the signal terminal is mounted to the circuit board, the sliding force generated by the contact between the first elastic arm and the circuit board and the sliding force generated by the contact between the second elastic arm and the circuit board may counteract each other in the extending direction thereof, thus preventing the signal terminal from contacting the non-corresponding pad of the circuit board incorrectly due to an excessive sliding distance. The abutting surface of the first abutting portion and the abutting surface of the second abutting portion are coplanar to collectively abut against the circuit board and are electrically connected to the same conductive path, such that the signal terminal may simultaneously establish two signal transmission paths with the same conductive path of the circuit board through the first elastic arm and the second elastic arm, thereby improving the signal transmission rate of the signal terminal.

To achieve the foregoing objective, the present invention adopts the following technical solutions: a signal terminal is configured to be electrically connected to a circuit board. The signal terminal includes: a main body; a contact portion, extending from one end of the main body; a first elastic arm, extending from the other end of the main body, wherein the first elastic arm includes a first extending arm bending and extending from the main body and a first abutting arm bending and extending reversely from the first extending arm; an attaching portion, connected to the main body at an attaching location adjacent to the first elastic arm, wherein the attaching portion and the main body are provided to be integrally or separately formed, and the attaching portion is attached to the main body along a thickness direction thereof; and a second elastic arm, extending from one end of the attaching portion, wherein the second elastic arm includes a second extending arm extending from the attaching portion along a direction away from the first extending arm and a second abutting arm extending from the second extending arm toward the first abutting arm, the first abutting arm has a first abutting portion, the second abutting arm has a second abutting portion, and the first abutting portion and the second abutting portion are coplanar to be electrically connected to a same conductive path of the circuit board.

In certain embodiments, two through slots are formed by running through the first extending arm and the second extending arm respectively along thickness directions thereof, one of the two through slots extends to a bending connection location between the first extending arm and the main body, and the other of the two through slots extends to a bending connection location between the second extending arm and the attaching portion.

In certain embodiments, the first abutting portion is formed at a tail end of the first abutting arm, the second abutting portion is formed at a tail end of the second abutting arm, and the first abutting portion and the second abutting portion abut against a same conductive pad of the circuit board.

In certain embodiments, the first abutting arm extends beyond one side of the main body along a first direction, the second abutting arm extends beyond one side of the attaching portion toward the first abutting arm along the first direction, and the first abutting arm and the second abutting arm are provided to be staggered along the first direction.

In certain embodiments, the first abutting arm includes a first deviating portion connected to the first extending arm, the first abutting portion is formed by extending from the first deviating portion, a width of the first deviating portion gradually decreases along an extending direction toward the first abutting portion, the second abutting arm includes a second deviating portion connected to the second extending arm, the second abutting portion is formed by extending from the second deviating portion, a width of the second deviating portion gradually decreases along an extending direction toward the second abutting portion, and an extending direction of the first abutting portion is parallel to an extending direction of the second abutting portion.

In certain embodiments, a surface of the main body and a surface of the attaching portion are attached to each other by soldering, an extending length of the first extending arm and an extending length of the second extending arm are equal, and an extending length of the first abutting arm and an extending length of the second abutting arm are equal.

In certain embodiments, a connecting portion integrally extends from a side edge of the main body and is connected to a side edge of the attaching portion, a surface of the main body and a surface of the attaching portion are attached to each other and abut against each other by punching, an extending length of the first extending arm and an extending length of the second extending arm are substantially equal, and an extending length of the first abutting arm and an extending length of the second abutting arm are substantially equal.

The present invention further adopts the following technical solutions: an electrical connector is configured to be electrically connected to a circuit board. The electrical connector includes: an insulating base; and a plurality of terminal modules accommodated in the insulating base, wherein each of the terminal modules comprises an insulating block, two signal terminals fixed to the insulating block and a grounding shielding shell covering an outer side of the insulating block, the two signal terminals are configured to transmit a pair of differential signals, each of the signal terminals comprises a main body, a contact portion extending upward from the main body, and an attaching portion connected to the main body, the attaching portion and the main body are provided to be integrally or separately formed, the attaching portion is attached to the main body along a thickness direction thereof, a first elastic arm and a second elastic arm respectively extend from a lower end of the main body and a lower end of the attaching portion, the first elastic arm and the second elastic arm are exposed at a bottom portion of the insulating block, the first clastic arm includes a first extending arm connected to the main body and a first abutting arm bending and extending reversely from the first extending arm, the second elastic arm includes a second extending arm connected to the attaching portion and a second abutting arm bending and extending reversely from the second extending arm, the first extending arm and the second extending arm extend away from each other along a first direction perpendicular to an up-down direction, the first abutting arm and the second abutting arm extend toward each other along the first direction, the first abutting arm is provided at intervals with the second abutting arm along a second direction perpendicular to the first direction and the up-down direction, and the first abutting arm and the second abutting arm are configured to abut against and be electrically connected to a same conductive path of the circuit board.

In certain embodiments, in each of the two signal terminals, two outer side edges of the main body and two outer side edges of the attaching portion are provided to be aligned along thickness directions thereof, a converging portion is provided at a connection location between the main body and the first extending arm, an outer edge of the converging portion protrudes relative to outer edges of other portions of the main body along the second direction, and a distance between the two converging portions of the two signal terminals along the second direction is less than a distance between other portions of the two signal terminals.

In certain embodiments, a surface of the main body and a surface of the attaching portion are attached to each other by soldering, the thickness direction of the attaching portion is parallel to the first direction, the main body and the attaching portion are stacked along the first direction and fixed to the insulating block, an extending length of the first extending arm and an extending length of the second extending arm are substantially equal, and an extending length of the first abutting arm and an extending length of the second abutting arm are substantially equal.

In certain embodiments, a bottom portion of the grounding shielding shell passes downward beyond a bottom portion of the insulating block, a shielding space is surroundingly provided by the bottom portion of the grounding shielding shell and the bottom portion of the insulating block, the main body and the attaching portion pass downward beyond the bottom portion of the insulating block, the first extending arm and the second extending arm are located in the shielding space, the first abutting arm and the second abutting arm are respectively provided with a first abutting portion and a second abutting portion passing beyond the bottom portion of the grounding shielding shell, a plurality of grounding legs extend downward from the bottom portion of the grounding shielding shell, and the grounding legs are located at two opposite outer sides of the first abutting arm and the second abutting arm along the second direction.

In certain embodiments, along the up-down direction, gaps exist between the first extending arm and the second extending arm of each of the signal terminals and the bottom portion of the insulating block, and a distance between the first extending arm and the bottom portion of the insulating block and a distance between the second extending arm and the bottom portion of the insulating block are substantially equal.

In certain embodiments, along the first direction, a minimum distance between the first elastic arm of each of the signal terminals and the grounding shielding shell is substantially equal to a minimum distance between the second elastic arm of each of the signal terminals and the grounding shielding shell.

In certain embodiments, in each of the terminal modules, along the second direction, a minimum distance between the first elastic arm or the second elastic arm of one of the signal terminals and the grounding shielding shell is substantially equal to a minimum distance between the first elastic arm or the second elastic arm of the other of two signal terminals and the grounding shielding shell.

In certain embodiments, along the second direction, a distance between the first abutting portion and the second abutting portion of each of the signal terminals is less than a width of the first extending arm or the second extending arm.

In certain embodiments, the first abutting portion and the second abutting portion of each of the signal terminals have equal heights along the up-down direction, and the first abutting portion and the second abutting portion of each of the signal terminals abut against a same conductive pad of the circuit board.

In certain embodiments, in each of the terminal modules, a projection of one of the signal terminals along the up-down direction and a projection of the other of the signal terminals along the up-down direction are axially symmetrical with respect to a central line of an interval between the two signal terminals, and the two first abutting arms are located between the two second abutting arms or the two second abutting arms are located between the two first abutting arms.

In certain embodiments, in each of the terminal modules, a projection of one of the signal terminals along the up-down direction and a projection the other of the signal terminals along the up-down direction are 180 degrees rotationally symmetrical about a midpoint of an interval between the two signal terminals, and the first abutting arms and the second abutting arms are alternately arranged along the second direction.

In certain embodiments, the attaching portion is connected to the main body at an attaching location adjacent to the first elastic arm, and a width of the main body at the attaching location is smaller than a width of the main body at other locations without attaching to the attaching portion.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a partial exploded view of an electrical connector according to certain embodiments of the present invention.

FIG. 2 is a partial bottom view of an electrical connector according to certain embodiments of the present invention.

FIG. 3 is an enlarged schematic view of a region A in FIG. 2.

FIG. 4 is a perspective exploded view of a terminal module of an electrical connector according to certain embodiments of the present invention.

FIG. 5 is a perspective view of two signal terminals according to a first embodiment of the present invention.

FIG. 6 is a rear view of the two signal terminals according to the first embodiment of the present invention abutting against a circuit board.

FIG. 7 is a left view of a terminal module formed by the two signal terminals according to the first embodiment of the present invention.

FIG. 8 is a perspective view of two signal terminals according to a second embodiment of the present invention.

FIG. 9 is a left view of FIG. 8.

FIG. 10 is a bottom view of FIG. 8.

FIG. 11 is a bottom view of a terminal module formed by two signal terminals according to a third embodiment of the present invention.

FIG. 12 is a bottom view of a terminal module formed by signal terminal according to a fourth embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

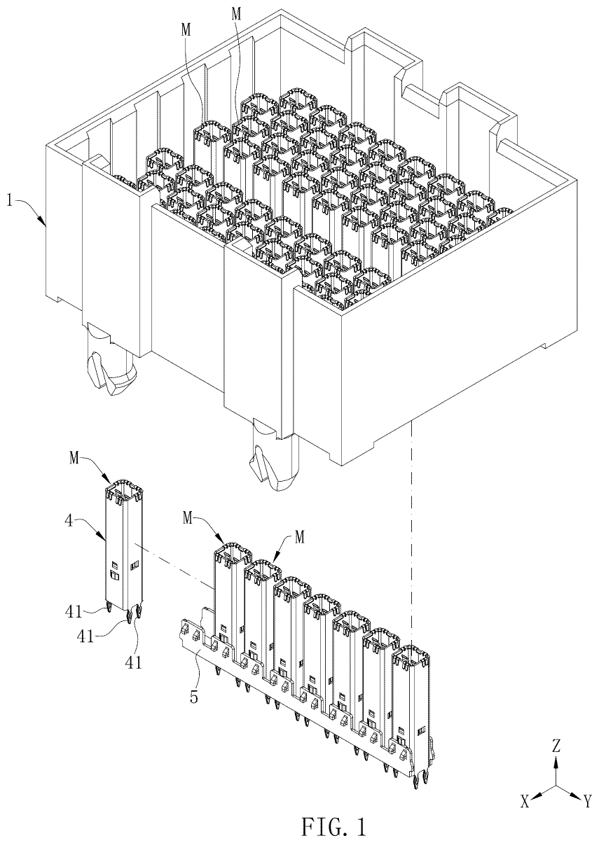

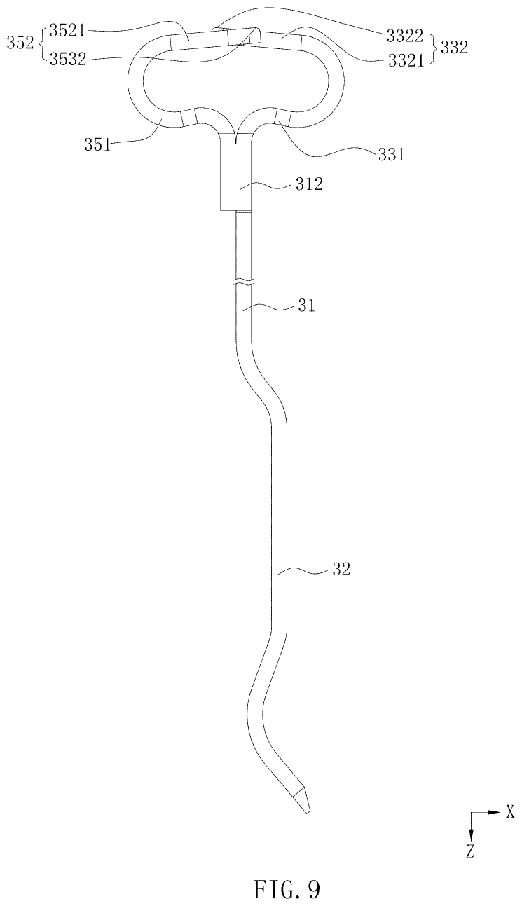

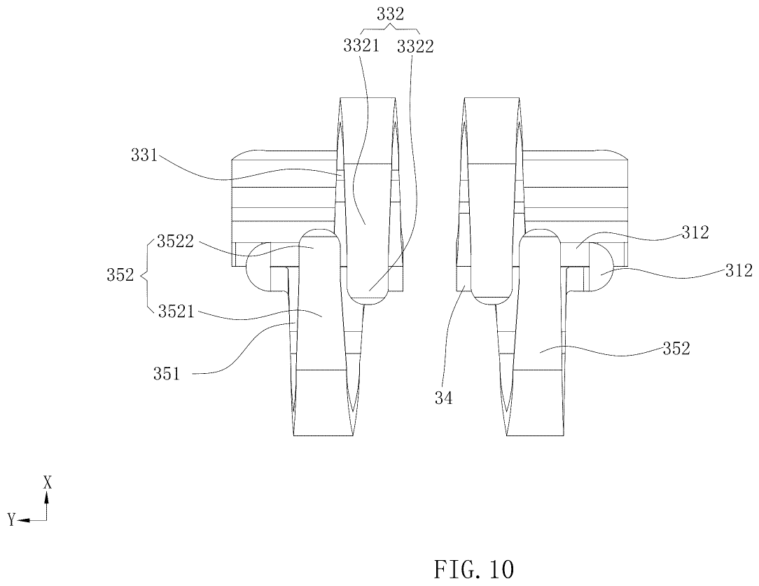

The description will be made as to the embodiments of the present invention in conjunction with the accompanying drawings in FIGS. 1-12. In accordance with the purposes of this invention, as embodied and broadly described herein, this invention, in one aspect, relates to a signal terminal and an electrical connector.

To better understand the objectives, structure, features, and effects of the present invention, the invention is further explained below with reference to the accompanying drawings and specific embodiments.

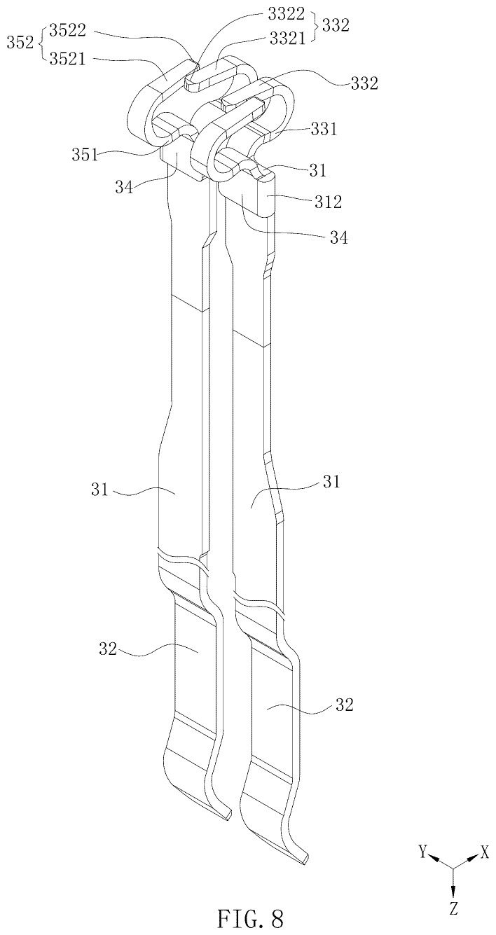

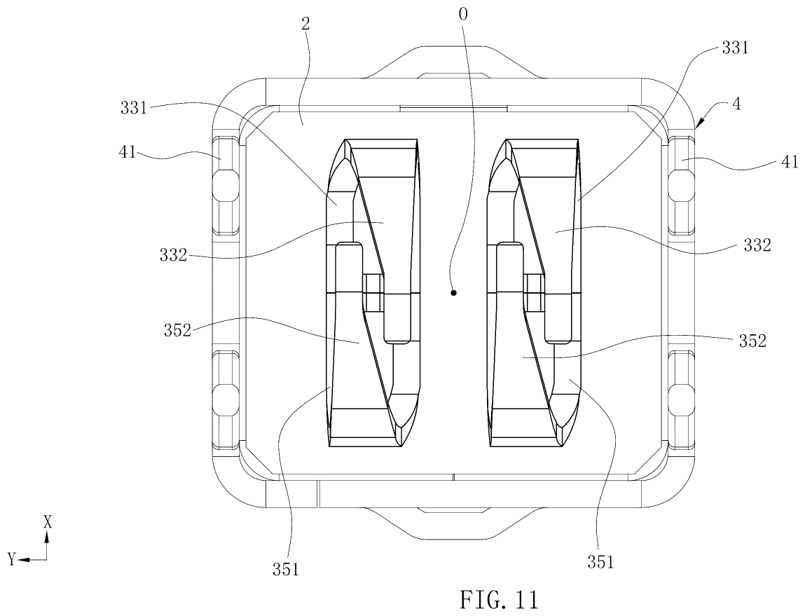

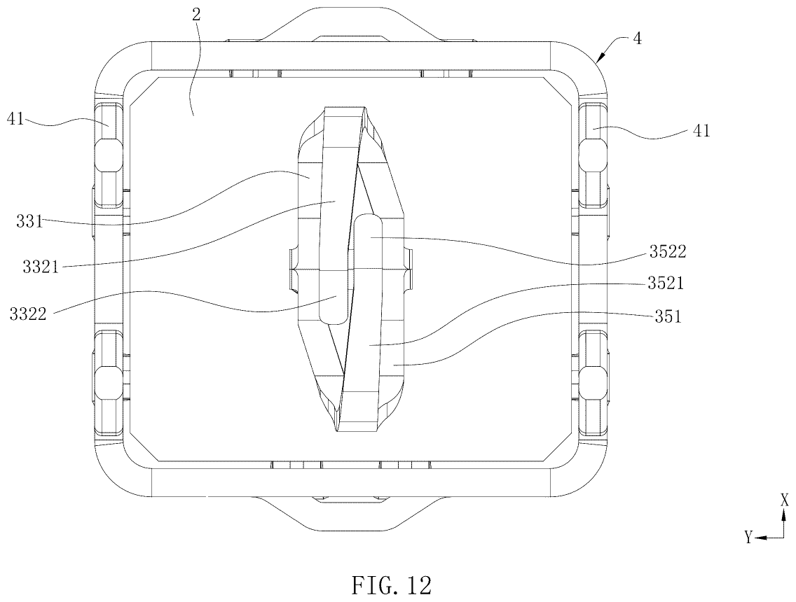

FIG. 1 to FIG. 12 show a signal terminal 3 and an electrical connector according to certain embodiments of the present invention. The electrical connector includes an insulating base 1 and a plurality of terminal modules M respectively accommodated in a plurality of accommodating slots 11 of the insulating base 1. Each terminal module M includes an insulating block 2 and one or two signal terminals 3 fixed in the insulating block 2. A grounding shielding shell 4 covers an outer side of the insulating block 2 to shield the signal terminals 3. The terminal modules M are arranged in multiple rows and multiple columns. The outer side of the terminal modules M in each row is provided with a grounding conductive sheet 5 connecting multiple grounding shielding shells 4. Each signal terminal 3 includes a main body 31 and an attaching portion 34, which is either integrally formed with or separately provided on the main body 31. The attaching portion 34 is attached to the main body 31 along a thickness direction thereof. A first clastic arm 33 extends from the main body 31, and a second elastic arm 35 extends from the attaching portion 34. The first elastic arm 33 includes a first extending arm 331 bending and extending from the main body 31 and a first abutting arm 332 bending and extending reversely from the first extending arm 331. The second elastic arm 35 includes a second extending arm 351 extending along a direction away from the first extending arm 331 and a second abutting arm 352 extending toward the first abutting arm 332. That is, the first extending arm 331 and the second extending arm 351 extend in directions away from each other, and the first abutting arm 332 and the second abutting arm 352 extend toward each other. Further, the first abutting portion 3322 of the first abutting arm 332 and the second abutting portion 3522 of the second abutting arm 352 are provided to be coplanar to collectively abut against the same conductive pad P of the circuit board 6, thereby facilitating being electrically connected to the same conductive path of the circuit board 6. FIG. 1 to FIG. 7 illustrate the signal terminals 3 as well as the terminal module and the electrical connector formed according to a first embodiment of the present invention. FIG. 8 to FIG. 10 illustrate the signal terminals according to a second embodiment of the present invention. FIG. 11 illustrates a terminal module formed by the signal terminals according to a third embodiment of the present invention. FIG. 12 illustrates a terminal module formed by the signal terminals according to a fourth embodiment of the present invention. In the first, second, and third embodiments, two signal terminals 3 and an insulating block 22 are accommodated in the grounding shielding shell 4 to form the terminal module M, and in the fourth embodiment, a single signal terminal 3 and an insulating block 22 are accommodated in the grounding shielding shell 4 to form the terminal module M. An up-down direction, a first direction and a second direction are marked in the coordinate axes of the accompanying drawings, in which the up-down direction is represented by the Z-axis, and the positive direction of the Z-axis is the upward direction. The first direction is perpendicular to the up-down direction and is represented by the X-axis, and the positive direction of the X-axis is the forward direction. The second direction is perpendicular to both the up-down direction and the first direction and is represented by the Y-axis, and the positive direction of the Y-axis is the rightward direction. In each of the embodiments, the first direction is a front-rear direction, and the second direction is a left-right direction. The thickness direction of the attaching portion 34 is parallel to the first direction.

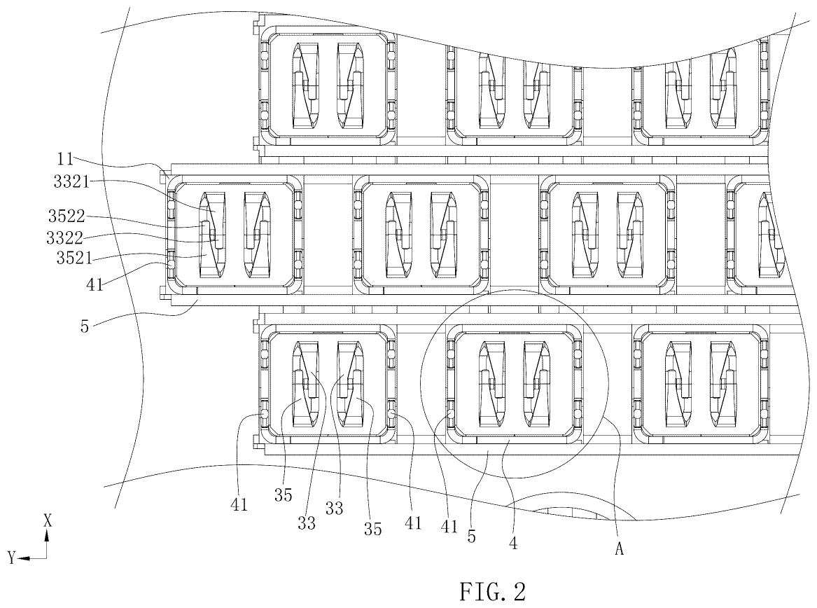

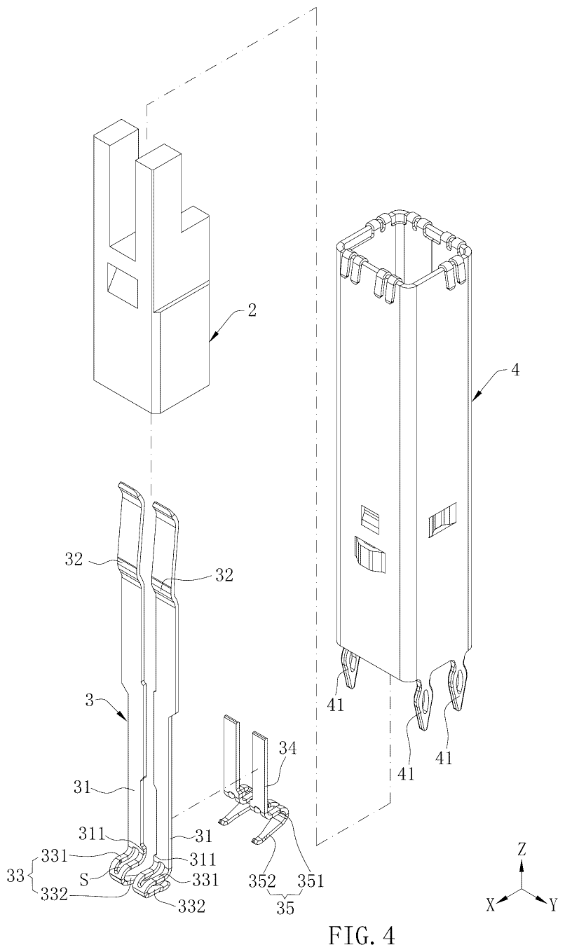

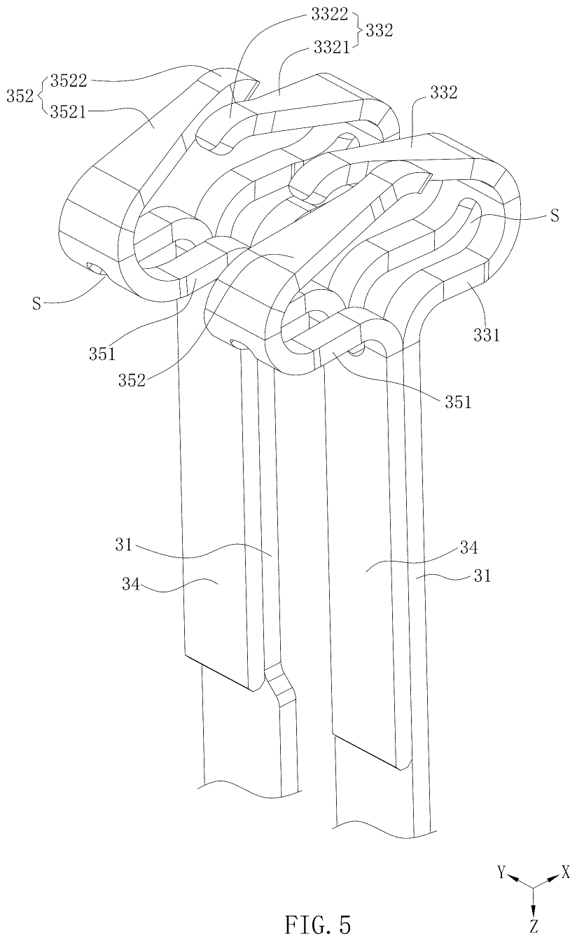

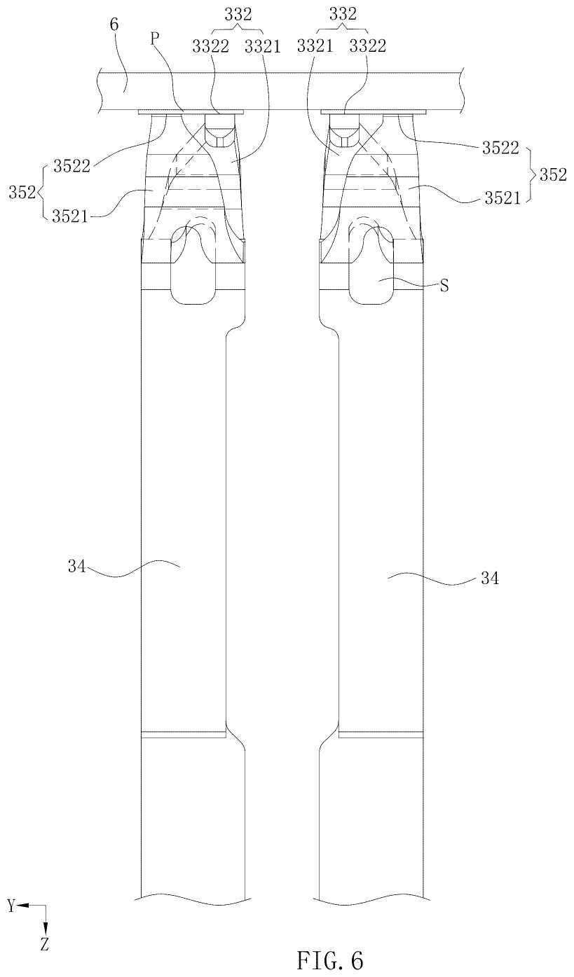

FIG. 4 and FIG. 5 show the two signal terminals according to the first embodiment of the present invention. A contact portion 32 extends from the upper end of the main body 31 of each signal terminal 3, and the contact portion 32 is used to be electrically connected with an external connector. A first elastic arm 33 extends from the lower end of the main body 31. The first elastic arm 33 includes a first extending arm 331 bending and extending forward from the lower end of the main body 31 and a first abutting arm 332 bending reversely and extending backward from the first extending arm 331. The first elastic arm 33 is formed by bending twice, such that the first elastic arm 33 has an additional reverse bending compared to the elastic arm in the related art, and the first elastic arm 33 has a longer moment arm and better elastic compression performance, facilitating stable elastic contact between the signal terminal 3 and the circuit board 6. The first extending arm 331 is provided with a through slot S along the thickness direction thereof. The through slot S extends to a bending connection location between the first extending arm 331 and the main body 31 as well as a reverse bending connection location between the first extending arm 331 and the first abutting arm 332, thus relieving the stress concentration at the two bending connection locations, and prolonging the usage life of the first elastic arm 33. The first abutting arm 332 includes a first deviating portion 3321 connected to the first extending arm 331 and a first abutting portion 3322 extending backward from the first deviating portion 3321. A width of the first deviating portion 3321 gradually decreases along the extending direction toward the first abutting portion 3322 (that is, backward from front thereof). Referring to FIG. 2 and FIG. 6, the two outer edges of the first deviating portion 3321 extend obliquely relative to the two outer edges of the first extending arm 331 and gradually converge along the second direction, and the overall width of the first deviating portion 3321 changes uniformly, thus preventing the first abutting arm 332 from stress concentration. The first deviating portion 3321 causes the central line of the first abutting portion 3322 to deviate in the second direction relative to the central line of the first extending arm 331. The width of the first abutting portion 3322 is equal to a minimum width of the first deviating portion 3321. According to the results of impedance analysis in the high-frequency simulation, the first extending arm 331 has a relatively high impedance, and the first abutting arm 332 has a relatively low impedance. Thus, the overall width of the first abutting arm 332 is reduced compared to the width of the first extending arm 331, which increases the impedance of the signal terminal 3 at the first abutting arm 332, thereby reducing the impedance difference between the first abutting arm 332 and the first extending arm 331, and facilitating the overall impedance matching for the signal terminal 3. Meanwhile, the width of the first abutting portion 3322 is minimized, and the width of the second abutting portion 3522 is also minimized, allowing the same conductive pad P of the circuit board 6 corresponding to the first abutting portion 3322 and the second abutting portion 3522 to have a correspondingly smaller width, thereby preventing the contact locations of the first abutting portion 3322 and the second abutting portion 3522 with the conductive pad P to have an excessively low impedance, increasing the lowest impedance value of the entire electrical connecting system in transmitting signals at the rate of 224 Gb/s, facilitating better characteristic impedance matching of the entire electrical connecting system, and reducing signal attenuation at the rate of 224 Gb/s. In this embodiment, the first abutting portion 3322 and the second abutting portion 3522 abut against the same conductive pad P to be connected to the same conductive path of the circuit board 6. In other embodiments (not shown), the first abutting portion 3322 and second abutting portion 3522 may abut against two conductive pads P respectively, provided that the two conductive pads P are conductive to the same conductive path within the circuit board 6, such that the first abutting portion 3322 and second abutting portion 3522 are electrically connected to the same conductive path on the circuit board 6.

As shown in FIG. 4 and FIG. 5, the attaching portion 34 is formed separately from the main body 31, and the rear surface of the main body 31 is fixedly attached to the front surface of the attaching portion 34 by soldering, such that the attaching portion 34 and the main body 31 abut against each other and are electrically connected. The attaching portion 34 is connected to the main body 31 at an attaching location adjacent to the first clastic arm 33. In addition, the thickness of the signal terminal 3 at the attaching location is greater than the thickness of other portions of the signal terminal 3, and the width of the main body 31 at the attaching location is smaller than the width of the main body 31 at other locations without attaching to the attaching portion 34. Further, the two outer side edges of the main body 31 and the two outer side edges of the attaching portion 34 are aligned along the thickness directions thereof, such that the main body 31 and the attaching portion 34 are electrically connected by being in surface contact with a maximum contact area. The second elastic arm 35, which extends from the attaching portion 34 has a structure similar to the first elastic arm 33. The second elastic arm 35 includes a second extending arm 351 extending from the lower end of the attaching portion 34 along a direction away from the first extending arm 331 (that is, bending and extending backward) and a second abutting arm 352 extending forward from the second extending arm 351 toward the first abutting arm 332 (that is, bending and extending forward). Thus, the second clastic arm 35 also bends twice, providing a longer moment arm and better elastic compression performance. Similarly, a through slot S is provided on the second extending arm 351 along the thickness direction thereof, and the through slot S extends to the bending connection location between the second extending arm 351 and the attaching portion 34 as well as to the reverse bending connection location between the second extending arm 351 and the second abutting arm 352, thus relieve the stress concentration at the two bending connection locations. Further, the two through slots S allow both the first extending arm 331 and the second extending arm 351 to become dual-arm structures, thus forming dual conductive transmission paths, which is conducive to reducing impedance and allows the overall impedance matching of the signal terminal 3. The second abutting arm 352 includes a second deviating portion 3521 connected to the second extending arm 351 and a second abutting portion 3522 extending forward from the second deviating portion 3521. The width of the second deviating portion 3521 gradually decreases along the extending direction of the second abutting arm 352 (that is, forward from rear thereof). The two outer side edges of the second deviating portion 3521 extend obliquely relative to the two outer side edges of the second extending arm 351 and gradually converging along the second direction, thus relieving the stress concentration of the second abutting arm 352. The width of the second abutting portion 3522 is equal to the minimum width of the second deviating portion 3521, which is conducive to reducing the impedance of the signal terminal 3 at the second abutting arm 352 at high frequencies, thus facilitating the overall impedance matching of the signal terminal 3.

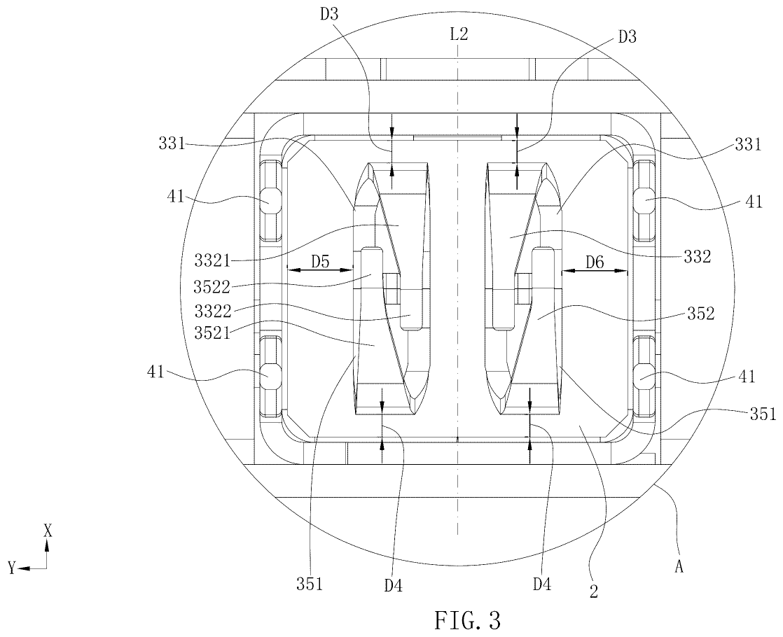

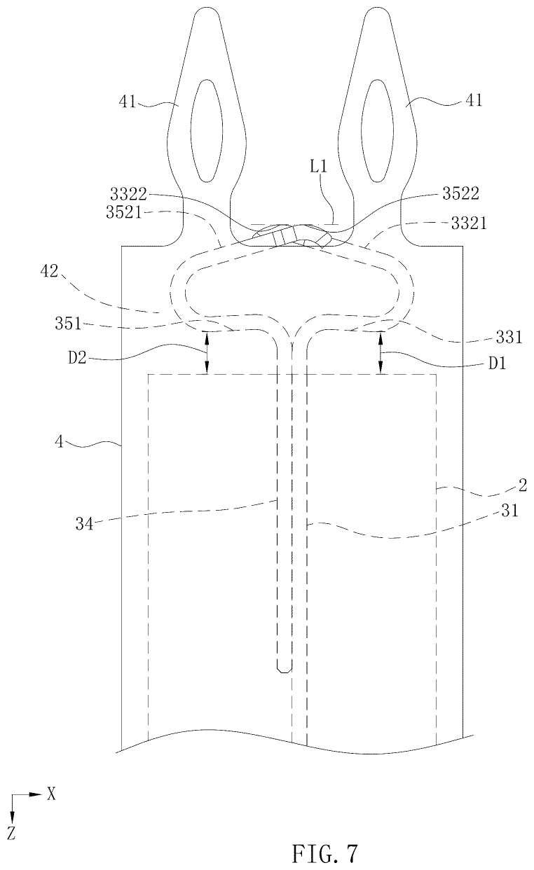

As shown in FIG. 5 to FIG. 7, the first extending arm 331 and the second extending arm 351 extend away from each other, and the first abutting arm 332 and the second abutting arm 352 extend toward each other. Specifically, the first extending arm 331 and the second extending arm 351 extend in opposite directions away from each other along the first direction, allowing the first elastic arm 33 and the second elastic arm 35 to form with longer moment arm structures. The first abutting arm 332 and the second abutting arm 352 extend toward each other along the first direction. Thus, when the signal terminal 3 is mounted onto the circuit board 6, the sliding force generated by the contact between the first elastic arm 33 and the circuit board 6 and the sliding force generated by the contact between the second elastic arm 35 and the circuit board 6 are opposite to each other in the first direction, such that the two forces cancel each other, thus preventing the signal terminal 3 and the conductive pad P of the circuit board 6 from staggered contact, and ensuring accurate contacts between the first abutting portion 3322, the second abutting portion 3522 and the corresponding conductive pad P. In addition, referring to FIG. 2 and FIG. 3, the first abutting arm 332 and the second abutting arm 352 are provided to be staggered along the first direction, preventing the first abutting arm 332 and the second abutting arm 352 from collision and deformation during sliding along the respective extending directions, and ensuring the structural stability of the first abutting arm 332 and the second abutting arm 352. In addition, as shown in the FIG. 7, the projections of the first abutting arm 332 and the second abutting arm 352 partially overlap in the second direction. Specifically, as shown in FIG. 3, the first abutting arm 332 may extend beyond the attaching portion 34, and the second abutting arm 352 may extend beyond the main body 31, such that both the first abutting arm 332 and the second abutting arm 352 have long moment arms. Referring to FIG. 6, the first abutting portion 3322 and the second abutting portion 3522 are located at a same height along the up-down direction. The abutting surface of the first abutting portion 3322 and the abutting surface of the second abutting portion 3522 are coplanar along the plane defined by dashed line L1. The first abutting portion 3322 and the second abutting portion 3522 form dual contact points to abut against the same conductive pad P of the circuit board 6, such that the signal terminal 3 may establish two signal transmission paths with the circuit board 6 through the first clastic arm 33 and the second elastic arm 35, thus increasing the signal transmission rate of the signal terminal 3. The extending lengths of the first extending arm 331 and the second extending arm 351 are equal, and the extending lengths of the first abutting arm 332 and the second abutting arm 352 are equal, such that the transmission path lengths of the two signal conductive paths are equal, thus preventing the periodic resonance caused by unequal transmissions through the signal transmission path lengths. The term “equal” herein refers to being substantially equal. That is, the tolerance may exist in the manufacturing process, and the tolerance range of ±0.2 mm is allowed.

Along the first direction, the distance between the end of the first abutting portion 3322 and the end of the second abutting portion 3522 is less than the extending lengths of the first extending arm 331 and the second extending arm 351, such that the space occupied by the first abutting portion 3322 and the second abutting portion 3522 is reduced along the first direction. Along the second direction, the distance between the first abutting portion 3322 and the second abutting portion 3522 is less than the widths of the first extending arm 331 and the second extending arm 351, and the two outer side edges of the first abutting portion 3322 and the second abutting portion 3522 are provided to be further inward compared to the two outer side edges of any of the first extending arm 331 and the second extending arm 351, such that the space occupied by the first abutting portion 3322 and the second abutting portion 3522 is reduced along the second direction, facilitating miniaturization of the signal terminal 3 and miniaturization of the corresponding conductive pad P of the circuit board 6, which is conducive to disposing more signal terminals 3 within the limited space.

As shown in FIG. 4 and FIG. 7, in each terminal module M, the two signal terminals 3 form a differential signal pair for transmitting high frequency differential signals. The insulating block 2 partially covers the outer side of the two signal terminals 3 to fix the two signal terminals 3. Specifically, the contact portions 32 of the signal terminals 3 are exposed at the upper end of the insulating block 2, and the first elastic arms 33 and the second elastic arms 35 are exposed at the bottom portion of the insulating block 2, thereby being electrically connected to an external connector and the circuit board 6 respectively. The main body 31 and the attaching portion 34 attached to each other are molded and covered within the insulating block 2, such that the main body 31 and the attaching portion 34 are further tightly attached, facilitating the face-to-face tightly abutment of the surface of the main body 31 and the surface of the attaching portion 34. Referring to FIG. 4 and FIG. 6, the connection location between the main body 31 and the first extending arm 331 includes a converging portion 311, and an outer edge of the converging portion 311 protrudes compared to the outer edges of other portions of the main body 31 along the second direction. The two converging portions 311 of the two signal terminals 3 protrude toward each other along the second direction, such that the distance between the two converging portions 311 of the two signal terminals 3 is less than the distance between other portions of the main bodies 31 of the two signal terminals 3, and the two signal terminals 3 form a tight coupling at the converging portions 311, thus reducing the crosstalk between the two signal terminals 3 in terminal module M and other signal terminals 3 in the other terminal modules M. The outer edges of the attaching portion 34 are also correspondingly aligned with the outer edges of the converging portion 311. When viewing from the bottom in FIG. 2 and FIG. 3, in each terminal module M, the projection of one signal terminal 3 along the up-down direction and the projection of the other signal terminal 3 along the up-down direction are provided to be axially symmetrical along the central line L2 of an interval between the two signal terminals. In this embodiment, the two first abutting arms 332 are located between the two second abutting arms 352, thus facilitating the tight coupling of the internal signal traces between two conductive pads P on the circuit board 6, and enhancing the signal transmission quality. In other embodiments (not shown), the two second abutting arms 352 may be located between the two first abutting arms 332.

As shown in FIG. 1, FIG. 4 and FIG. 7, the cylindrical-shaped grounding shielding shell 4 surrounds the four side surfaces of the insulating block 2, thus providing shielding around the two signal terminals 3, and reducing the crosstalk interference between the two signal terminals 3 and other signal terminals 3 at the outer side. In FIG. 7, the contours of the insulating block 2 and the signal terminals 3 being shielded are shown by dashed lines. The bottom portion of the grounding shielding shell 4 passes beyond the bottom portion of the insulating block 2, thus collectively forming a shielding space 42 between the bottom portion of the grounding shielding shell 4 and the bottom portion of the insulating block 2. The main body 31 and the attaching portion 34 pass downward beyond the bottom portion of the insulating block 22, and the first elastic arm 33 and second elastic arm 35 are located within the shielding space 42. The shielding space 42 provides sufficient room for the first elastic arm 33 and the second elastic arm 35 to elastically deform and to be reliably electrically connected to the conductive pad P of the circuit board 6. Further, the first extending arm 331 and the second extending arm 351 do not pass beyond the bottom portion of the grounding shielding shell 4 and are thus totally shielded. The first abutting portion 3322 and the second abutting portion 3522 pass beyond the bottom portion of the grounding shielding shell 4, thus ensuring the first abutting portion 3322 and the second abutting portion 3522 to be in unhindered contact with the conductive pads P without being limited by the bottom portion of the grounding shielding shell 4. Further, multiple grounding legs 41 extend from the bottom portion of the grounding shielding shell 4, and the grounding legs 41 are provided on the two opposite outer sides of the two signal terminals 3. Referring to FIG. 2, two grounding legs 41 respectively extend from the left and right side walls of the grounding shielding shell 4, such that the grounding legs 41, the first abutting arm 332 and the second abutting arm 352 are staggered along the first direction, thus preventing the first abutting arm 332 and the second abutting arm 352 from accidentally contacting the grounding legs 41 during the mounting, preventing short-circuiting between the signal terminals 3 and the grounding shielding shell 4. Further, along the second direction, multiple grounding legs 41 are provided to be isolated between every two signal terminals 3, thus reducing the signal crosstalk between the adjacent terminal modules M. As shown in FIG. 3, the overall structures of the first elastic arm 33 and the second elastic arm 35 in each signal terminal 3 are symmetrical by 180 degrees rotating about the center of the signal terminal 3, such that the lengths and widths of the first elastic arm 33 and the second elastic arm 35 are correspondingly equal. As shown in FIG. 7, the first extending arm 331 and the second extending arm 351 of each signal terminal 3 are at intervals with the bottom portion of the insulating block 22 along the up-down direction. Along the up-down direction, the distance D1 between the first extending arm 331 and the insulating block 2 is substantially equal to the distance D2 between the second extending arm 352 and the insulating block 2. Along the first direction, the minimum distance between the first elastic arm 33 and the grounding shielding shell 4 is substantially equal to the minimum distance between the second elastic arm 35 and the grounding shielding shell 4. Specifically, the distance D3 between the reverse bending connection location of the first extending arm 331 and the first abutting arm 332 and one side of the grounding shielding shell 4 is substantially equal to the distance D4 between the reverse bending connection location of the second extending arm 351 and the second abutting arm 352 and the opposite side of the grounding shielding shell 4, such that the surrounding medium distributions around the first elastic arm 33 and the second elastic arm 35 are identical. That is, the distances between the first elastic arm 33 and the second elastic arm 35 and the surrounding plastic medium (the insulating block 2) maintain substantially equal (D1=D2), and the distances between the first elastic arm 33 and the second elastic arm 35 and the surrounding conductive medium (the grounding shielding shell 4) also maintain substantially equal (D3=D4), which helps ensure the impedances for the signal transmission path established by the first elastic arm 33 and the signal transmission path established by the second elastic arm 35 to be identical, and the electromagnetic field distribution around the first elastic arm 33 and the second elastic arm 35 is uniform, which is conducive to signal transmission, preventing inconsistencies between the two signal transmission paths.

As shown in FIG. 3, the first elastic arm 33 and the second elastic arm 35 of each signal terminal 3 are symmetrical by rotating. Along the second direction, the distances between the first elastic arm 33 as well as the second elastic arm 35 of each signal terminal 3 and the same side of the grounding shielding shell 4 are substantially equal, and in each terminal module M, along the second direction, the minimum distance between the first elastic arm 33 or the second elastic arm 35 of one signal terminal 3 and the grounding shielding shell 4 is substantially equal to the distance between the first elastic arm 33 or the second elastic arm 35 of the other signal terminal 3 and the grounding shielding shell 4. Specifically, the distance D5 between the first elastic arm 33 of one signal terminal 3 and one side of the grounding shielding shell 4 is substantially equal to the distance D6 between the first elastic arm 33 of the other signal terminal 3 and the opposite side of the grounding shielding shell 4. Similarly, the distance between the second elastic arm 35 of one signal terminal 3 and one side of the grounding shielding shell 4 is substantially equal to the distance between the second elastic arm 35 of the other signal terminal 3 and the other side of the grounding shielding shell 4, such that the distances between the two signal terminals 3 transmitting the differential signals and the grounding shielding shell 4 are substantially equal, thereby ensuring synchronization between the two signal terminals during transmission of a pair of differential signals, avoiding the skewing issues, and ensuring the signal completeness. The term “substantially equal” in the description refers to the case where, since the tolerance may exist in the manufacturing process, and the tolerance range of ±0.2 mm is allowed, any measurement within this tolerance range may be considered substantially identical.

FIG. 8 to FIG. 10 show two signal terminals 3 according to the second embodiment of the present invention, which differ from the two signal terminals 3 in the first embodiment in that, in this second embodiment, the attaching portion 34 of each signal terminal 3 is formed by integrally extending from the main body 31. A connecting portion 312 integrally extends from the outer edge of the main body 31 away from the other signal terminal 3 and is connected to the side edge of the attaching portion 34. The main body 31 and the attaching portion 34 are formed by punching and folded along the first direction to attach to each other. The external insulating block 2 covers the main body 31 and the attaching portion 34 to prevent the connecting portion 312 and the attaching portion 34 from springing back (not shown). The side edge of the attaching portion 34 closer to the other signal terminal 3 aligns with the side edge of the main body 31 closer to the other signal terminal 3, thus ensuring the maximum contact and conductive area between the attaching portion 34 and the main body 31. In this second embodiment, the first elastic arm 33 of each signal terminal 3 also includes a first extending arm 331 and a first abutting arm 332, and the second elastic arm 35 also includes a second extending arm 351 and a second abutting arm 352, such that the first elastic arm 33 and the second elastic arm 35 have good elasticity by bending twice. The first extending arm 331 and the second extending arm 351 extend away from each other in the first direction, and the first abutting arm 332 and the second abutting arm 352 extend toward each other in the first direction. When mounted on the circuit board 6, the two sliding forces generated by the first elastic arm 33 and the second elastic arm 35 in the first direction cancel each other out, thus preventing the signal terminal 3 and the conductive pad P of the circuit board 6 from staggered contact. The first abutting arm 332 also includes a first deviating portion 3321 and a first abutting portion 3322, and the second abutting arm 352 also includes a second deviating portion 3521 and a second abutting portion 3522, such that the two outer edges of the first abutting portion 3322 and the second abutting portion 3522 are located further inward relative to the two outer edges of the first extending arm 331 and the second extending arm 351. The abutting surface of the first abutting portion 3322 and the abutting surface of the second abutting portion 3522 are coplanar to be in contact with the same conductive pad P, thus forming two conductive signal transmission paths between each signal terminal 3 and the circuit board 6 through the first elastic arm 33 and the second elastic arm 35.

FIG. 11 show two signal terminals 3 according to the third embodiment of the present invention, in which the structures of the signal terminals 3 are identical to the structures of the signal terminals 3 in the first embodiment. The two signal terminals 3 in the first embodiment are axially symmetrical, and the two signal terminals 3 in the third embodiment are symmetrical by rotating. Specifically, in the terminal module M, the projection of one signal terminal 3 along the up-down direction and the projection of the other signal terminal 3 along the up-down direction are symmetrical by rotating 180 degrees about the midpoint O of the interval between the two signal terminals 3, such that the first abutting arms 332 and the second abutting arms 352 are arranged alternately along the second direction.

FIG. 12 shows a signal terminal 3 and the terminal module M thereof according to the fourth embodiment of the present invention. The structure of the signal terminal 3 in this embodiment is substantially identical to the structures of the signal terminals 3 in the first embodiment. In the fourth embodiment, in the terminal module M, only one signal terminal 3 and the insulating block 2 are provided within the grounding shielding shell 4, and the signal terminal 3 is used to transmit single-ended signals and is provided to be centered within the grounding shielding shell 4. Along the first direction, the distance between the first elastic arm 33 of the signal terminal 3 and one side of the grounding shielding shell 4 is also equal to the distance between the second elastic arm 35 and the other side of the grounding shielding shell 4, and in the second direction, the distance between the first elastic arm 33 of the signal terminal 3 and one side of the grounding shielding shell 4 is equal to the distance between the second elastic arm 35 and the other side of the grounding shielding shell 4, thus ensuring the consistency between the two signal transmission paths established by the first elastic arm 33 and the second elastic arm 35, and ensuring the signal completeness.

In sum, the signal terminal 3 and the electrical connector according to the present invention have the following beneficial effects.

1. One side of the main body 31 of the signal terminal is attached to an attaching portion 34, and increasing the thickness of signal terminal 3 at the attaching location, thereby increasing the cross-sectional area of the signal terminal 3. The first elastic arm 33 extends from the main body 31 and the second elastic arm 35 extends from the attaching portion 34. The first elastic arm 33 includes a first extending arm 331 bending and extending from the main body 31 and a first abutting arm 332 bending and extending reversely from the first extending arm 331, and the second elastic arm 35 includes a second extending arm 351 extending along a direction away from the first extending arm 331 and a second abutting arm 352 extending toward the first abutting arm 332, such that the first elastic arm 33 and the second clastic arm 35 both bend and extend twice and have longer moment arms, increasing the elastic performance of the first elastic arm 33 and the second elastic arm 35, which is conducive to the good elastic contact between the signal terminal 3 and the circuit board 6. In addition, the first extending arm 331 and the second extending arm 351 extend away from each other, and the first abutting arm 332 and the second abutting arm 352 extend toward each other. When mounted on the circuit board 6, the sliding force generated by the contact between the first elastic arm 33 and the circuit board 6 and the sliding force generated by the contact between the second elastic arm 35 and the circuit board 6 cancel each other out in the extending directions of the first abutting arm 332 and the second abutting arm 352, thus preventing the signal terminal 3 and the circuit board 6 from staggered contact due to an excessive sliding distance. The first abutting arm 332 and the second abutting arm 352 are partially coplanar to collectively abut against the circuit board 6 and to be connected to the same conductive path, such that the signal terminal 3 may simultaneously establish two signal transmission paths with the same conductive path of the circuit board 6 through the first clastic arm 33 and the second elastic arm 35, thereby improving the signal transmission rate of the signal terminal 3.

2. The first extending arm 331 is provided with a through slot S along the thickness direction thereof, and the through slot S extends to the bending connection location between the first extending arm 331 and the main body 31 as well as the reverse bending connection location between the first extending arm 331 and the first abutting arm 332, thus relieving the stress concentration at the two bending connection locations, prolonging the usage life of the first elastic arm 33.

3. The width of the first deviating portion 3321 gradually decreases along the extending direction toward the first abutting portion 3322, such that the width changes uniformly to reduce the stress concentration. The width of the first abutting portion 3322 is equal to the minimum width of the first deviating portion 3321. According to the results of impedance analysis in high-frequency simulation, the first extending arm 331 has a relatively high impedance, and the first abutting arm 332 has a relatively low impedance. Thus, the overall width of the first abutting arm 332 is reduced compared to the width of the first extending arm 331, which increases the impedance of the signal terminal 3 at the first abutting arm 332, thereby reducing the impedance difference between the first abutting arm 332 and the first extending arm 331, and facilitating the overall impedance matching for the signal terminal 3. Meanwhile, the width of the first abutting portion 3322 is minimized, and the width of the second abutting portion 3522 is also minimized, allowing the corresponding same conductive pad P of the circuit board 6 to have a smaller width, thereby preventing the contact locations of the first abutting portion 3322 and the second abutting portion 3522 with the conductive pad P to have an excessively low impedance, increasing the lowest impedance value of the entire electrical connecting system during signal transmission at the rate of 224 Gb/s, facilitating better characteristic impedance matching of the entire electrical connecting system, and reducing signal attenuation at the rate of the 224 Gb/s.

4. The extending lengths of the first extending arm 331 and the second extending arm 351 are equal, and the extending lengths of the first abutting arm 332 and the second abutting arm 352 are equal, such that the transmission path lengths of the two signal conductive transmission paths are equal, thus preventing the periodic resonance caused by unequal transmissions through the transmission path lengths.

5. In each terminal module M, the grounding legs 41 are provided on the two opposite outer sides of the two signal terminals 3, such that the grounding legs 41, the first abutting arm 332 and the second abutting arm 352 are staggered along the first direction, thus preventing the first abutting arm 332 and the second abutting arm 352 from accidentally contacting the grounding legs 41 during the mounting, preventing short-circuiting between the signal terminals 3 and the grounding shielding shell 4.

6. Along the up-down direction, the first extending arm 331 and the second extending arm 351 of each signal terminal 3 are at intervals with the bottom portion of the insulating block 22. Along the up-down direction, the distance D1 between the first extending arm 331 and the insulating block 2 is substantially equal to the distance D2 between the second extending arm 352 and the insulating block 2. The distance D3 between the reverse bending connection location of the first extending arm 331 and the first abutting arm 332 and one side of the grounding shielding shell 4 is substantially equal to the distance D4 between the reverse bending connection locations of the second extending arm 351 and the second abutting arm 352 and the opposite side of the grounding shielding shell 4, such that the surrounding medium distributions around the first elastic arm 33 and the second elastic arm 35 are identical. That is, the distances between the first elastic arm 33 and the second elastic arm 35 and the surrounding plastic medium (the insulating block 2) maintain substantially equal (D1=D2), and the distances between the first elastic arm 33 and the second elastic arm 35 and the surrounding conductive medium (the grounding shielding shell 4) also maintain substantially equal (D3=D4), which helps ensure the impedances for the signal transmission path established by the first elastic arm 33 and the signal transmission path established by the second elastic arm 35 to be identical, and the electromagnetic field distribution around the first elastic arm 33 and the second elastic arm 35 is uniform, which is conducive to signal transmission, preventing inconsistencies between the two signal transmission paths that cause the skewing issues.

7. In each terminal module M, along the second direction, the distance D5 between the first elastic arm 33 of one signal terminal 3 and one side of the grounding shielding shell 4 is substantially equal to the distance D6 between the first elastic arm 33 of the other signal terminal 3 and the opposite side of the grounding shielding shell 4. Similarly, the distance between the second elastic arm 35 of one signal terminal 3 and one side of the grounding shielding shell 4 is substantially equal to the distance between the second elastic arm 35 of the other signal terminal 3 and the other side of the grounding shielding shell 4, such that the distances between the two signal terminals 3 transmitting the differential signals and the grounding shielding shell 4 are substantially equal, thereby ensuring synchronization between the two signal terminals during transmission of a pair of differential signals, avoiding the skewing issues, and ensuring the signal completeness.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A signal terminal, configured to be electrically connected to a circuit board, the signal terminal comprising:
a main body;
a contact portion, extending from one end of the main body;
a first elastic arm, extending from the other end of the main body, wherein the first elastic arm includes a first extending arm bending and extending from the main body and a first abutting arm bending and extending reversely from the first extending arm;
an attaching portion, connected to the main body at an attaching location adjacent to the first elastic arm, wherein the attaching portion and the main body are provided to be integrally or separately formed, and the attaching portion is attached to the main body along a thickness direction thereof; and
a second elastic arm, extending from one end of the attaching portion, wherein the second elastic arm includes a second extending arm extending from the attaching portion along a direction away from the first extending arm and a second abutting arm extending from the second extending arm toward the first abutting arm, the first abutting arm has a first abutting portion, the second abutting arm has a second abutting portion, and the first abutting portion and the second abutting portion are coplanar to be electrically connected to a same conductive path of the circuit board.

2. The signal terminal according to claim 1, wherein two through slots are formed by running through the first extending arm and the second extending arm respectively along thickness directions thereof, one of the two through slots extends to a bending connection location between the first extending arm and the main body, and the other of the two through slots extends to a bending connection location between the second extending arm and the attaching portion.

3. The signal terminal according to claim 1, wherein the first abutting portion is formed at a tail end of the first abutting arm, the second abutting portion is formed at a tail end of the second abutting arm, and the first abutting portion and the second abutting portion abut against a same conductive pad of the circuit board.

4. The signal terminal according to claim 1, wherein the first abutting arm extends beyond one side of the main body along a first direction, the second abutting arm extends beyond one side of the attaching portion toward the first abutting arm along the first direction, and the first abutting arm and the second abutting arm are provided to be staggered along the first direction.

5. The signal terminal according to claim 1, wherein the first abutting arm includes a first deviating portion connected to the first extending arm, the first abutting portion is formed by extending from the first deviating portion, a width of the first deviating portion gradually decreases along an extending direction toward the first abutting portion, the second abutting arm includes a second deviating portion connected to the second extending arm, the second abutting portion is formed by extending from the second deviating portion, a width of the second deviating portion gradually decreases along an extending direction toward the second abutting portion, and an extending direction of the first abutting portion is parallel to an extending direction of the second abutting portion.

6. The signal terminal according to claim 1, wherein a surface of the main body and a surface of the attaching portion are attached to each other by soldering, an extending length of the first extending arm and an extending length of the second extending arm are equal, and an extending length of the first abutting arm and an extending length of the second abutting arm are equal.

7. The signal terminal according to claim 1, wherein a connecting portion integrally extends from a side edge of the main body and is connected to a side edge of the attaching portion, a surface of the main body and a surface of the attaching portion are attached to each other and abut against each other by punching, an extending length of the first extending arm and an extending length of the second extending arm are substantially equal, and an extending length of the first abutting arm and an extending length of the second abutting arm are substantially equal.

8. An electrical connector, configured to be electrically connected to a circuit board, the electrical connector comprising:
an insulating base; and
a plurality of terminal modules accommodated in the insulating base, wherein each of the terminal modules comprises an insulating block, two signal terminals fixed to the insulating block and a grounding shielding shell covering an outer side of the insulating block, the two signal terminals are configured to transmit a pair of differential signals, each of the signal terminals comprises a main body, a contact portion extending upward from the main body, and an attaching portion connected to the main body, the attaching portion and the main body are provided to be integrally or separately formed, the attaching portion is attached to the main body along a thickness direction thereof, a first elastic arm and a second elastic arm respectively extend from a lower end of the main body and a lower end of the attaching portion, the first elastic arm and the second elastic arm are exposed at a bottom portion of the insulating block, the first elastic arm includes a first extending arm connected to the main body and a first abutting arm bending and extending reversely from the first extending arm, the second elastic arm includes a second extending arm connected to the attaching portion and a second abutting arm bending and extending reversely from the second extending arm, the first extending arm and the second extending arm extend away from each other along a first direction perpendicular to an up-down direction, the first abutting arm and the second abutting arm extend toward each other along the first direction, the first abutting arm is provided at intervals with the second abutting arm along a second direction perpendicular to the first direction and the up-down direction, and the first abutting arm and the second abutting arm are configured to abut against and be electrically connected to a same conductive path of the circuit board.

9. The electrical connector according to claim 8, wherein in each of the two signal terminals, two outer side edges of the main body and two outer side edges of the attaching portion are provided to be aligned along thickness directions thereof, a converging portion is provided at a connection location between the main body and the first extending arm, an outer edge of the converging portion protrudes relative to outer edges of other portions of the main body along the second direction, and a distance between the two converging portions of the two signal terminals along the second direction is less than a distance between other portions of the two signal terminals.

10. The electrical connector according to claim 8, wherein a surface of the main body and a surface of the attaching portion are attached to each other by soldering, the thickness direction of the attaching portion is parallel to the first direction, the main body and the attaching portion are stacked along the first direction and fixed to the insulating block, an extending length of the first extending arm and an extending length of the second extending arm are substantially equal, and an extending length of the first abutting arm and an extending length of the second abutting arm are substantially equal.

11. The electrical connector according to claim 8, wherein a bottom portion of the grounding shielding shell passes downward beyond a bottom portion of the insulating block, a shielding space is surroundingly provided by the bottom portion of the grounding shielding shell and the bottom portion of the insulating block, the main body and the attaching portion pass downward beyond the bottom portion of the insulating block, the first extending arm and the second extending arm are located in the shielding space, the first abutting arm and the second abutting arm are respectively provided with a first abutting portion and a second abutting portion passing beyond the bottom portion of the grounding shielding shell, a plurality of grounding legs extend downward from the bottom portion of the grounding shielding shell, and the grounding legs are located at two opposite outer sides of the first abutting arm and the second abutting arm along the second direction.

12. The electrical connector according to claim 11, wherein along the up-down direction, gaps exist between the first extending arm and the second extending arm of each of the signal terminals and the bottom portion of the insulating block, and a distance between the first extending arm and the bottom portion of the insulating block and a distance between the second extending arm and the bottom portion of the insulating block are substantially equal.

13. The electrical connector according to claim 11, wherein along the first direction, a minimum distance between the first elastic arm of each of the signal terminals and the grounding shielding shell is substantially equal to a minimum distance between the second elastic arm of each of the signal terminals and the grounding shielding shell.

14. The electrical connector according to claim 11, wherein in each of the terminal modules, along the second direction, a minimum distance between the first elastic arm or the second elastic arm of one of the signal terminals and the grounding shielding shell is substantially equal to a minimum distance between the first elastic arm or the second elastic arm of the other of two signal terminals and the grounding shielding shell.

15. The electrical connector according to claim 11, wherein along the second direction, a distance between the first abutting portion and the second abutting portion of each of the signal terminals is less than a width of the first extending arm or the second extending arm.

16. The electrical connector according to claim 11, wherein the first abutting portion and the second abutting portion of each of the signal terminals have equal heights along the up-down direction, and the first abutting portion and the second abutting portion of each of the signal terminals abut against a same conductive pad of the circuit board.

17. The electrical connector according to claim 8, wherein in each of the terminal modules, a projection of one of the signal terminals along the up-down direction and a projection of the other of the signal terminals along the up-down direction are axially symmetrical with respect to a central line of an interval between the two signal terminals, and the two first abutting arms are located between the two second abutting arms or the two second abutting arms are located between the two first abutting arms.

18. The electrical connector according to claim 8, wherein in each of the terminal modules, a projection of one of the signal terminals along the up-down direction and a projection the other of the signal terminals along the up-down direction are 180 degrees rotationally symmetrical about a midpoint of an interval between the two signal terminals, and the first abutting arms and the second abutting arms are alternately arranged along the second direction.

19. The electrical connector according to claim 8, wherein the attaching portion is connected to the main body at an attaching location adjacent to the first elastic arm, and a width of the main body at the attaching location is smaller than a width of the main body at other locations without attaching to the attaching portion.
